(19) United States
(12) Patent Application Publication
(10) Pub. No.: US 2004/0164183 A1
(43) Pub. Date: Aug. 26, 2004

(54) Water dispensing head for a handshower

(76) Inventor: Fabrizio Nobili, San Vittore (CH)

Correspondence Address: Modiano & Associati, Via Meravigli 16, Milano, 20123, IT

(21) Appl. No.: 10/479,164

(22) PCT Filed: Nov. 21, 2001
(86) PCT No.: PCT/EP01/13525

(30) Foreign Application Priority Data
Jun. 4, 2001 (IT) MN2001A000026

(51) Int. Cl. A62C 31/00

(52) U.S. Cl. 239/449; 239/443; 239/444; 239/448

(57) ABSTRACT

A head (1) for dispensing water in a handshower, comprising a cover (2) that is associated in a fixed manner with the end of a water feed duct (3) and comprises means for connection to an underlying rotatable dispenser (9) that is adapted to selectively convey the water to diffusers that produce different jets; the connection means comprise two ceramic plates (7,8) that are in mutual contact and are perforated, one plate (7) being monolithic with the fixed cover (2), the other plate (8) being rigidly coupled to the rotatable dispenser (9).

### BACKGROUND OF THE INVENTION

The invention relates to a water dispensing head adapted to be used in a handshower.

It is known that the water dispensing heads provided in handshowers at the end of a water feed duct contained within a covering enclosure comprise, in a very common embodiment, a cover that is fixed to the end of the duct and has, at the surface that makes contact with the water conveyed by the duct, a port for the passage of the water to the region below the cover, where there is a rotatable dispenser.

As a consequence of a rotation of the dispenser performed by the user, said passage port is selectively connected to different ports provided in the dispenser, which convey the water toward different diffusers that are associated with the dispenser and are suitable to cause the water to exit in the form of different jets.

In the known art, the surface of the cover that is provided with the water passage port directly faces the surface of the dispenser that is provided with the various ports, and correct conveyance of the water from the port provided in the cover to a port provided in the dispenser occurs thanks to the presence of gaskets at the peripheral region of said ports, but it is readily evident that less than optimum operation is achieved and that a sufficient durability is not ensured.

### SUMMARY OF THE INVENTION

The aim of the present invention is therefore to provide a water dispensing head in a handshower that ensures gentle actuation for users and very long durability.

This aim is achieved by a dispensing head, according to the invention, comprising a cover that is associated in a fixed manner with the end of a water feed duct contained within a covering enclosure, and comprises means for connection to an underlying rotatable dispenser that is adapted to selectively convey the water to diffusers suitable to cause the water to exit in the form of different jets, characterized in that said connection means comprise two ceramic plates that are in mutual contact and are perforated, one plate being rigidly coupled to the fixed cover, the other plate being rigidly coupled to the rotatable dispenser.

### BRIEF DESCRIPTION OF THE DRAWINGS

Further characteristics and advantages of the present invention will become better apparent from the description of a preferred but not exclusive embodiment of the invention, illustrated only by way of non-limitative example in the accompanying drawings, wherein:

FIG. 1 is a sectional view of a handshower provided with the head according to the invention;

FIG. 2 is a perspective sectional view of the head, taken along a longitudinal plane;

FIGS. 3 and 4 are perspective exploded views of the head;

FIGS. 5 and 6 are two different perspective views of the dispenser, with some parts removed;

FIGS. 7, 8 and 9 are sectional views of three different operating conditions.

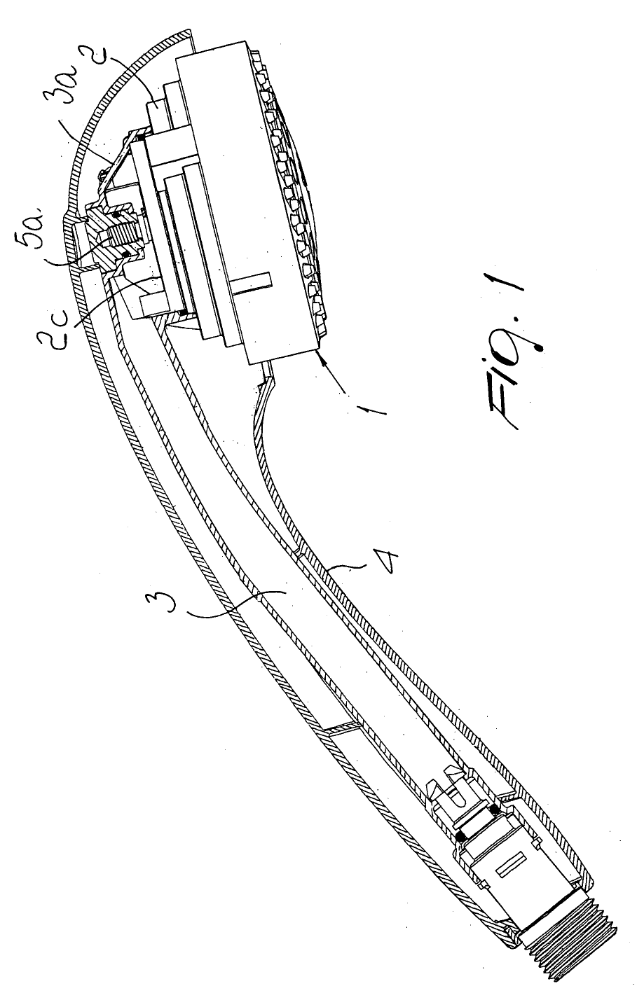

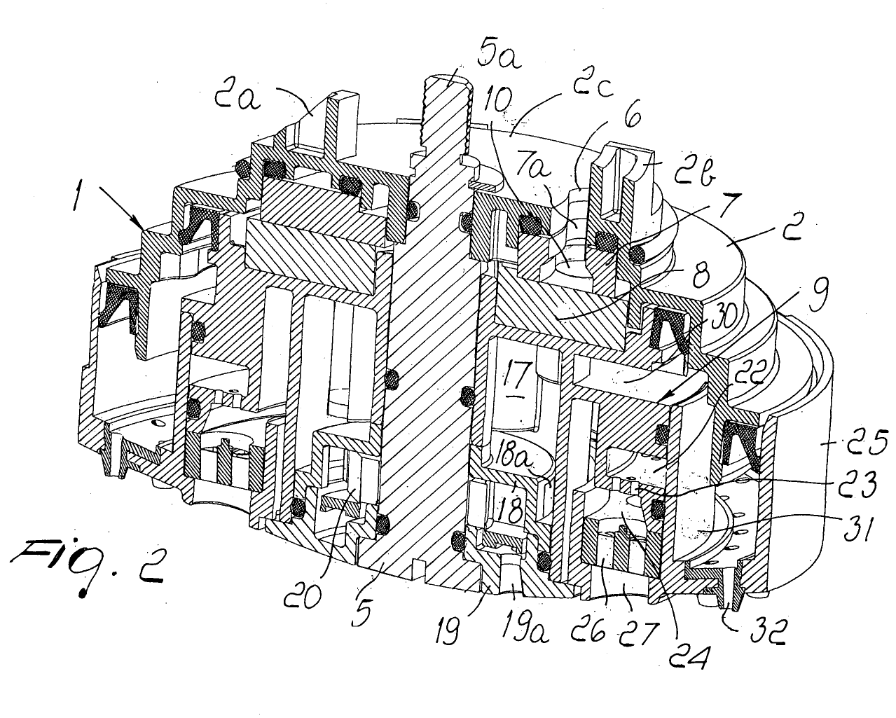

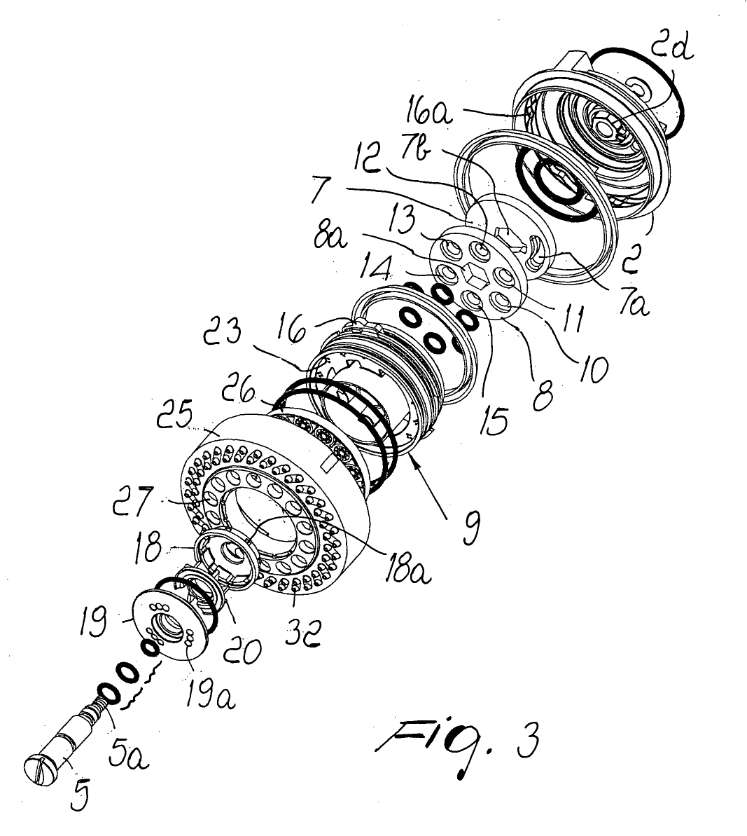

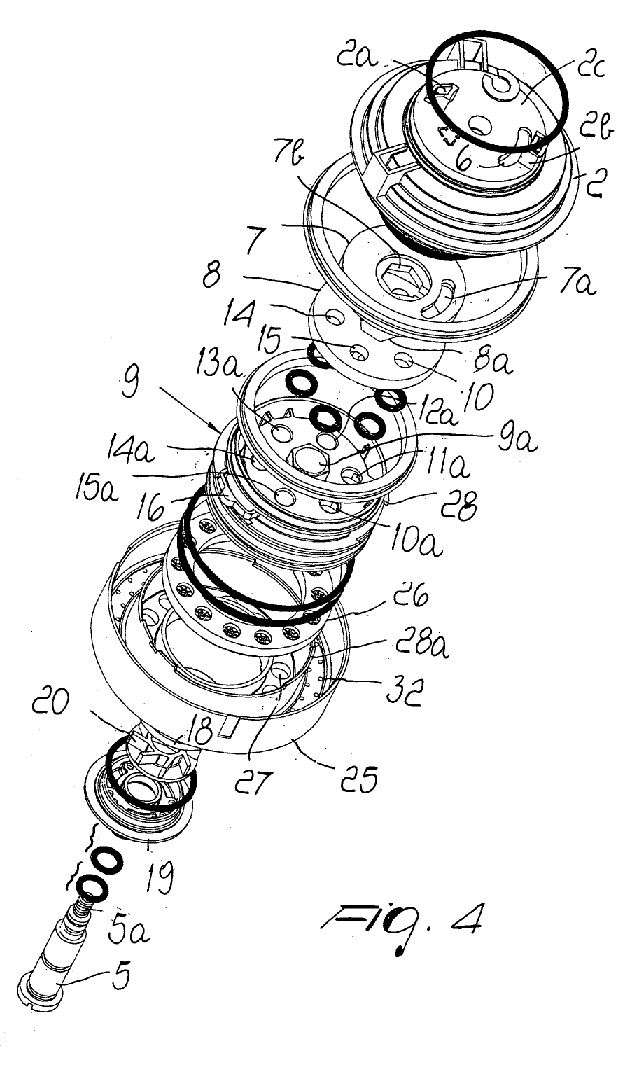

### DESCRIPTION OF THE PREFERRED EMBODIMENTS

With reference to the figures, the reference numeral 1 generally designates a head, which comprises a cover 2, which is associated with a hood 3a provided at the end of a water feed duct 3 contained within a covering enclosure 4 and is provided with lugs 2a and 2b that prevent rotation with respect to the hood; all the elements of the head described hereafter are held together by a central stem 5, whose upper end 5a is threaded in order to fix the head to the hood 3a.

The cover 2, which has a slot 6 at the surface 2c designed to be reached by the water conveyed by the duct 3, has a ceramic plate 7 rigidly coupled thereto; the plate 7 is provided with a slot 7a and is fixed with respect to the cover 2 by the association of a hexagonal hole 7b with the complementarily shaped protrusion 2d of the cover in the position in which the slot 7a is arranged at the slot 6 provided in the cover.

The ceramic plate 8 is in contact with the fixed ceramic plate 7 and is rigidly coupled to a rotatable dispenser 9 by the association of the hexagonal hole 8a with a complementarily shaped protrusion 9a of the dispenser; said plate 8 is provided with uniformly distributed holes 10, 11, 12, 13, 14, 15 at holes 10a, 11a, 12a, 13a, 14a, 15a that are provided in the rotatable dispenser 9 and are suitable to selectively convey the water to the diffusers, described hereafter, for forming different jets.

The slots 6 and 7a have a circumferential shape that allows them to be placed at two consecutive holes provided in the plate 8 and in the dispenser 9, in positions determined by the elastic insertion of a locator 16 provided at the peripheral region of the rotatable dispenser 9 in seats such as 16a provided in the cover 2; in this way, by turning the dispenser 9 in the manners described hereinafter, the user places different pairs of the holes provided in the plate 8 and in the dispenser 9 at the slots 6 and 7a and provides the different operating conditions that are now described.

The two holes 10a, 11a of the first pair are provided with apertures, respectively designated by the reference numerals 10b and 11b, which are open onto a portion of space 17 formed within the dispenser 9 and are connected to openings such as 18a that are provided in a conveyor 18 for conveying the water to ports such as 19a of a central diffuser 19, with an impeller 20 interposed in order to create a pulsating central jet.

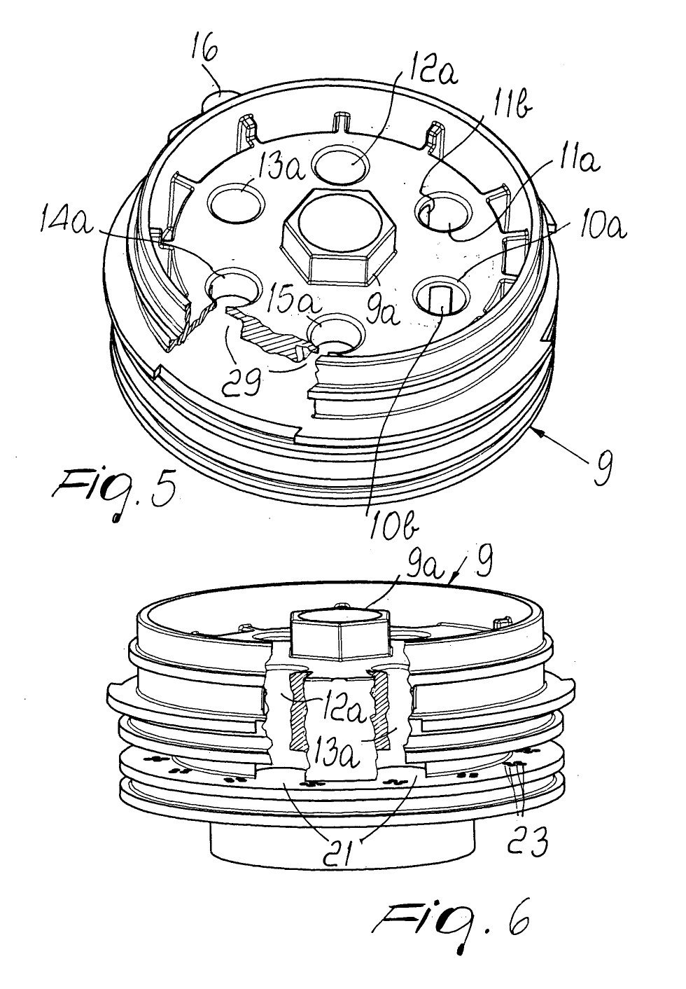

This is the situation shown in FIG. 7, which occurs when, as a consequence of the rotation of the dispenser 9, the holes 10a, 11a and the corresponding holes 10, 11 are connected to the slots 6 and 7a.

The two holes 12a, 13a of the second pair lead to a port 21, in a portion of space 22 that is connected by means of small holes such as 23 to a portion of space 24, formed within an external diffuser 25, which gives access, with a flow regulator element 26 interposed, to ports such as 27 provided in the external diffuser 25 to create an intermediate jet.

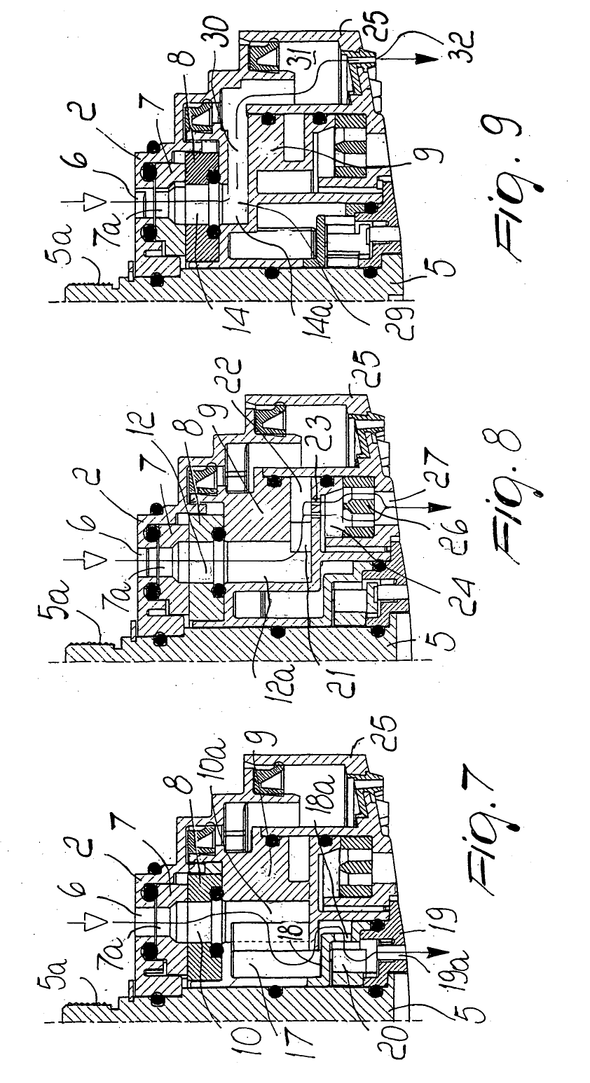

This is the situation shown in FIG. 8, which occurs when the holes 12a and 13a and the corresponding holes 12 and 13 are connected to the slots 6 and 7a.

It should be noted at this point that there are locators, such as 28 and 28a, respectively on the dispenser 9 and on the external diffuser 25, which rotationally rigidly couple them, so that the user turns the dispenser 9 by acting on the external diffuser 25; the central diffuser 19 is in turn rotated by the dispenser 9 by friction.

The two holes 14a, 15a of the third pair lead to the port 29, which is open onto a portion of space 30 that is connected to a section 31 of the external diffuser 25, provided with ports such as 32 to create a peripheral jet.

This is the situation shown in FIG. 9, which occurs when the holes 14a, 15a and the corresponding holes 14, 15 are connected to the slots 6 and 7a.

Intermediate situations, in which the water exits from the holes of two contiguous jets, can occur if holes that belong to different pairs are arranged so as to face the slots 6 and 7a; for example, if the holes 11a and 12a are made to face said slots, water exits partially from the holes such as 19a of the central jet and partially from the holes such as 27 of the intermediate jet.

From the above description it is easily understandable that the presence of the ceramic plates ensures very gentle actuation, watertightness, and great durability.

The described invention is susceptible of numerous modifications and variations, all of which are within the scope of the inventive concept; moreover, for example, the dispenser can assume any shape.

A dispenser such as the one described may also be associated with means for connection to the cover of the head of a known type.

The disclosures in Italian Patent Application No. MN2001A000026 from which this application claims priority are incorporated herein by reference.

1. A head for dispensing water in a handshower, comprising a cover that is associated in a fixed manner with the end of a water feed duct contained within a covering enclosure, and comprising means for connection to an underlying rotatable dispenser that is adapted to selectively convey the water to diffusers suitable to cause the water to exit in the form of different jets, characterized in that said connection means comprise two ceramic plates that are in mutual contact and are perforated, one plate being rigidly coupled to the fixed cover, the other plate being rigidly coupled to the rotatable dispenser.

2. The head according to claim 1, characterized in that the ceramic plate rigidly coupled to the fixed cover is provided with a slot arranged at a corresponding slot formed within a surface at the top of the cover, which is suitable to receive the water conveyed by the feed duct, the ceramic plate rigidly coupled to the rotatable dispenser being provided with holes arranged at corresponding holes that are formed within the dispenser and are suitable to convey the water to different diffusers.

3. The head according to one or more of the preceding claims, characterized in that the ceramic plates rigidly coupled respectively to the fixed cover and to the rotatable dispenser comprise polygonal central holes that are suitable to be associated with complementarily shaped protrusions provided respectively in said fixed cover and in said rotatable dispenser.

4. The head according to one or more of the preceding claims, characterized in that the slot provided in the ceramic plate that is rigidly coupled to the fixed cover has a circumferential shape that allows it to be placed at at least two of the holes provided in the plate that is rigidly coupled to the rotatable dispenser.

5. The head according to one or more of the preceding claims, characterized in that the slot provided in the ceramic plate that is rigidly coupled to the fixed cover has a circumferential shape that allows it to be placed at two consecutive holes provided uniformly on the ceramic plate that is rigidly coupled to the rotatable dispenser.

6. The head according to one or more of the preceding claims, characterized in that it comprises a locator that is suitable to determine, in the relative motion of the rotatable dispenser with respect to the fixed cover, the positions in which the slot provided in the plate that is rigidly coupled to said cover is arranged at two holes provided in the plate that is rigidly coupled to said dispenser.

7. The head according to one or more of the preceding claims, characterized in that it comprises a central stem that is suitable to keep in position all the elements that compose said head and is provided with an upper end that is threaded in order to provide assembly with the water feed duct.

8. The head according to one or more of the preceding claims, characterized in that the ceramic plate rigidly coupled to the rotatable dispenser has six uniformly distributed holes arranged at three pairs of holes provided in said dispenser, a first pair of holes being connected to a central diffuser provided with ports suitable to produce a central jet, a second pair of holes being connected to ports provided in an external diffuser and suitable to produce an intermediate jet, a third pair of holes being connected to ports provided in said external diffuser and suitable to produce a peripheral jet.

9. The head according to one or more of the preceding claims, characterized in that each one of the holes of the first pair provided in the rotatable dispenser has, in the wall, an aperture that opens onto a portion of space formed within said dispenser and connected to openings provided in an element for conveying the water to the ports of the central diffuser, with the interposition of an impeller to create a pulsed jet.

10. The head according to one or more of the preceding claims, characterized in that the holes of the second pair provided in the rotatable dispenser end at a port that is provided in a portion of the wall of the dispenser and opens onto a portion of space that is delimited by said wall portion, by two additional annular wall portions, and by a portion of the wall of the external diffuser, the annular wall portion of the dispenser that is arranged downward being provided with holes for the passage of the water, with a flow regulator element interposed, toward ports provided in said external diffuser in order to create an intermediate jet.

11. The head according to one or more of the preceding claims, characterized in that the holes of the third pair provided in the rotatable dispenser lead to a port that is provided in a wall portion of the dispenser and is open onto a portion of space that is directly connected to a section of the external diffuser that is provided with ports for forming a peripheral jet.

12. The head according to one or more of the preceding claims, characterized in that the dispenser is provided with locators suitable to engage complementarily shaped seats provided in the external diffuser, so as to rotationally rigidly couple said dispenser and said diffuser, the central diffuser being turned by friction by said dispenser.

13. A water dispensing head in a handshower, comprising a cover that is associated so as to be fixed at the end of a water feed duct contained within a covering enclosure and comprises means for connection to an underlying rotatable dispenser, characterized in that said dispenser is provided with three pairs of holes suitable to be selectively connected to said means: namely, a first pair of holes, connected to a central diffuser provided with ports suitable to produce a central jet; a second pair of holes, connected to ports provided in an external diffuser and suitable to produce an intermediate jet; and a third pair of holes, connected to ports provided in said external diffuser and suitable to produce a peripheral jet.

14. The head according to claim 13, characterized in that each one of the holes of the first pair provided in the rotatable dispenser is provided, within the wall, with an aperture that opens onto a portion of space formed within said dispenser and is connected to openings provided in an element for conveying the water to the ports of the central diffuser, with the interposition of an impeller for creating a pulsed jet.

15. The head according to claim 13, characterized in that the holes of the second pair provided in the rotatable dispenser lead at a port that is formed in a portion of the wall of the dispenser and opens onto a portion of space that is delimited by said wall portion, by two additional annular wall portions, and by a portion of the wall of the external diffuser, the downward annular wall portion of the dispenser being provided with holes for the passage of water, with a flow regulator element interposed, toward ports provided in said external diffuser in order to create an intermediate jet.

16. The head according to claim 13, characterized in that the holes of the third pair provided in the rotatable dispenser lead at a port that is provided in a portion of the wall of the dispenser and opens onto a portion of space that is directly connected to a section of the external diffuser that is provided with ports for creating a peripheral jet.
